(19) United States
(12) Patent Application Publication
(10) Pub. No.: US 2009/0070197 A1
(43) Pub. Date: Mar. 12, 2009

(54) METHOD FOR ELECTRONIC DATA COLLECTION ABOUT PRODUCTS AND SERVICES AND RELATED ELECTRONIC SYSTEM

(75) Inventor: Alessandro ERMOLLI, Milan (IT)

Correspondence Address: OBLON, SPIVAK, MCCLELLAND MAIER & NEUSTADT, P.C., 1940 DUKE STREET, ALEXANDRIA, VA, 22314, US

(73) Assignee: SIN&RGETICA S.r.l, Milan (IT)

(21) Appl. No.: 12/208,822

(22) Filed: Sep. 11, 2008

(30) Foreign Application Priority Data
Sep. 12, 2007 (IT) MI2007A 001754

(51) Int. Cl. G06Q 30/00; G06Q 10/00

(52) U.S. Cl. 705/10

(57) ABSTRACT

The present invention refers to a method for electronic data collection about products and/or services through a virtual community made up of a plurality of discussion groups wherein the virtual community is managed by a company and a related electronic system. The method (100) of the present invention comprises steps consisting of receiving (110) a plurality of data about the product or service input by a plurality of users participating in a discussion group about the product or service; processing (120) the data input about the product or service in order to obtain market information about the product or service; offer the processed market information for sale (130); and redistribute (140) a percentage of the earnings obtained from the sale of the information among the users of the discussion group in terms of money or an instrument giving the users the right to a fraction of the company capital. In addition, the method for electronic data collection about products and/or services also comprises the step of remunerating (150) the users participating in a discussion group which have provided the received information in terms of instruments giving them the right to a fraction of the company capital, independently from the sale of the processed market information.

The present invention refers to a method for electronic data collection about products and/or services and a related electronic system.

With regard to collecting data about products or services, several different techniques have been developed pertaining to the concept of market research. Market research principally consists of the study and analysis of the behaviors expressed by, and the decision-making processes of, consumers in a market economy, or of the definition of the structure of a market, in this way selecting all relevant information elements that can be used for decisions regarding products or services, for example the definition of the characteristics of the product or service, the setting of the price, the positioning of the product or service in the market, the choice of promotional techniques and suchlike.

Such techniques involve for example the collection of information about a product or service from a representative sample of consumers, said information being about the appreciation of same.

To this end, the assessments and comments of a group of consumers about a product or service tested by them, or known to them, or of interest to them, are collected. The collection of this data can be done in various different ways.

There are market research companies, which can be entrusted with the task of collecting such information. These companies generally proceed by defining a group of target persons, held to be representative of the market sector at which the product or service is aimed, and a list of questions to obtain, from the individual consumers, comments that are consistent with each other. The data therefore is generally collected by means of interviews that follow criteria that are specially defined for the purpose.

Following collection of the data, the market research company processes the data in such a way as to extrapolate relevant information from it about the product or service being tested.

Lastly, the information produced by the market research company is sold to the commissioning customer company. The consumers who take part in the test generally receive, as the only stimulus to participate, a free sample of the product to be tested or, for example, a trial access to the service to be tested, with a time limitation.

The stimulus to effectively participate in the market research is therefore often already diminished at the time of collecting the data, which is usually done only after consumption of the product or enjoyment of the service.

Such a market research project is usually very costly, particularly because of the difficulty in identifying and finding representative consumers who are willing to actively participate.

This is why for some time now comments and votes on products or services have been collected over a communications network, for example the Internet, by means of which it is easier to reach a significant group of people.

There are Internet portals where a consumer can provide a comment on products or services belonging to one particular category (vertical assessment) or to multiple categories (horizontal assessment).

The only stimulus to participate is given by the benefit that that consumer derives from a numerous participation of consumers.

The assessments and comments entered can be viewed, free of charge or otherwise, by all users, who can thus obtain a highly detailed picture of information about the product or service of interest to them, and in this way be assisted in their purchasing choice.

In addition, this information is processed by the companies owning and operating the portals for the purpose of selling on relevant information about products or services to their makers or providers.

Often, this reprocessing of data is difficult because the data is mainly collected without supervision and therefore it is often internally inconsistent or difficult to develop into relevant information.

For example, if the consumers' contributions are collected in the form of a free text description of their experience with the product or service, then in order to obtain relevant information it will be necessary to carefully read each description and identify and extrapolate any points they have in common.

Such processing therefore requires a lengthy working process that is difficult to automate.

In addition, despite the stimulus to participate to provide comments about a product or service as described above, it is not always possible to collect a data set that is sufficient or related to specific topics of particular interest so as to be able to derive information that is consistent.

Thus, the purpose of the present invention is to devise a method for the electronic data collection about products and/or services that guarantees motivated participation by consumers, wherein with data about products and/or service reference is made to both objective and subjective data like for instance opinions, experiences with the product or service, etc. Another purpose of the present invention is to devise a method for the electronic data collection about products and/or service that facilitates the processing of the collected data, guaranteeing the collection of data that is related to topics of particular interest.

A further purpose of the present invention is to create an electronic market research system for implementing the electronic data collection method in accordance with the present invention.

Another object of the present invention is to create a market research system that helps companies to get a reliable, open-minded and motivational consumer feedback on their products.

These and other purposes, according to the present invention, are achieved by devising a method for the electronic data collection about products and/or services as stated in claim 1.

Further characteristics of the method are the subject of the dependent claims.

The characteristics and advantages of a method for the electronic data collection about products and/or services in accordance with the present invention will be more evident from the following description, which is provided by way of example only and is not exhaustive, referring to the enclosed schematic drawings in which:

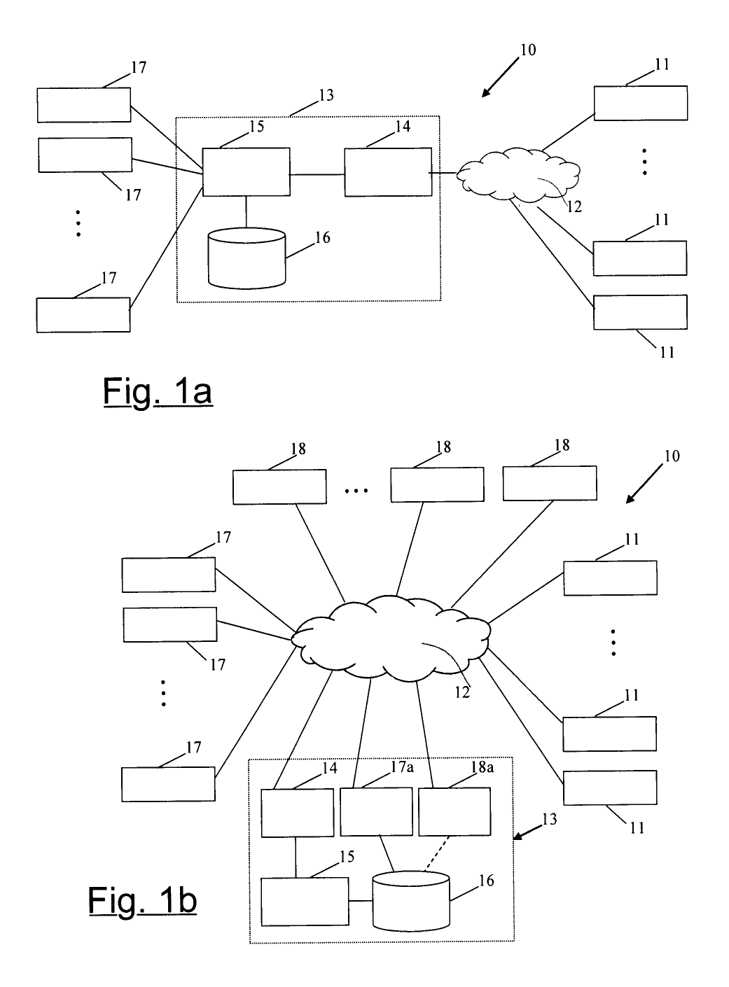

FIG. 1a is a schematic representation of a first version of the electronic system for data collection about products or services;

FIG. 1b is a schematic representation of a second version of the electronic system for data collection about products or services;

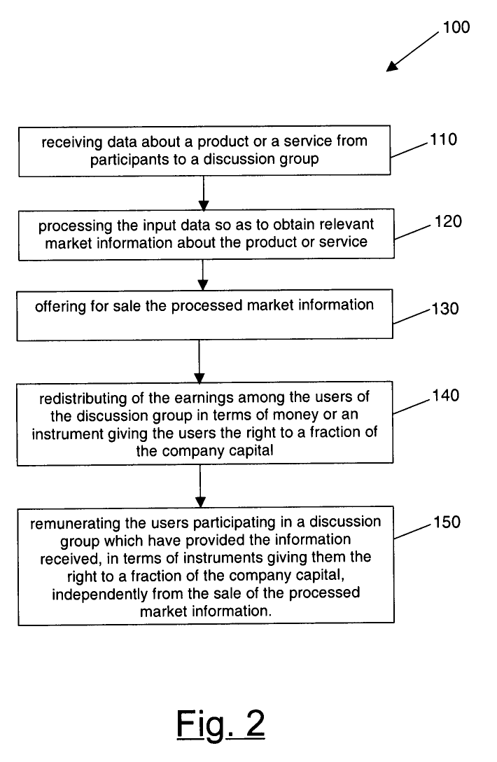

FIG. 2 is a block diagram of the method of electronic data collection about products and/or services according to the present invention;

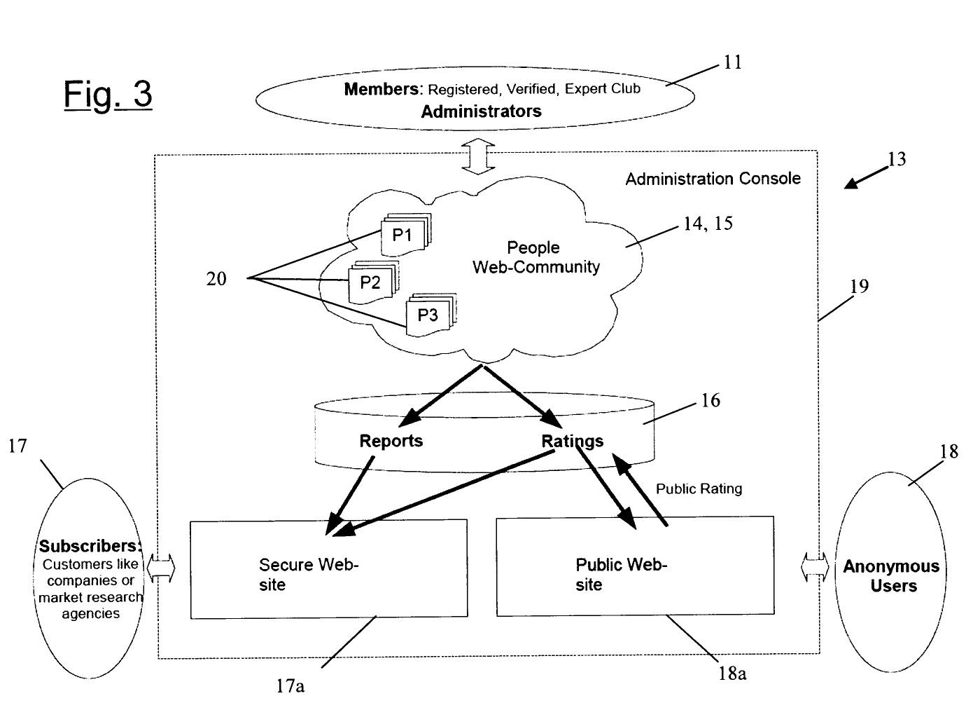

FIG. 3 is a schematic representation of a preferred embodiment of the electronic system for data collection about products and/or services according to the present invention.

In the figures an electronic system for the data collection about products and/or services is shown, referred to as 10.

The system 10 comprises a plurality of user terminals 11 for accessing a communications network 12, for example the Internet.

Similarly, the communications network 12 may be a local network, for example a LAN (local area network), PAN (personal area network), WAN (wide area network), VPN (virtual private network) or other type of network.

The user terminals 11 are preferably computers, for example personal computers, each of which is equipped with a data input device, for example a keyboard, and a data display device, for example a screen.

Over the communications network 12, the “members” namely users who have signed up for the data exchange service can access a unit 13 for managing data about the product and/or service, which comprises a portal 14 suitable for providing a common interface across the user terminals 11 and the unit 13 for managing data about the product and/or service.

By means of the user terminals 11 it is possible to exchange data with the data managing unit 13 through the portal 14 which provides the data requested, for example in the form of web pages, or transfers the input data to appropriate devices for collecting and processing data 15.

The devices for collecting and processing data 15 communicate with databases 16 in which the data input by means of the user terminals 11 is collected.

The unit 13 for managing data about the product and/or service may also be connected directly or over the communication network 12 to terminals 17 of a plurality of customer companies, to which the collected data is transferred after being processed to produce information about the product or service.

In case the connection to the terminals 17 of the customer companies is made over the communication network 12, a second portal 17a is foreseen which limits the full access to the data input in the databases 16 only to subscribers, namely to customer companies having subscribed the data and information delivery service.

Preferably, a further portal 18a is foreseen for users 18 which have neither signed up for the data exchange service nor subscribed the data and information delivery service. This further portal 18a offers a limited access to only part of the data and information collected in the database 16.

Specifically, the method 100 implemented by the system 10 for the electronic collection of data about products and/or services comprises the following steps.

The first step that takes place is the collection 110 of data about a product or service by means of a data exchange service like a virtual community.

The data about a product or service, in terms of quantitative and/or qualitative assessments, is provided by a plurality of users who access the system 10 for the electronic collection of information by means of the user interfaces 11. Also, analytic information of all spending done with a special community credit card are collected.

After signing up for the data exchange service by, for example, creating a profile (i.e. account) for that user which is identifiable by means of a plurality of personal information and socio-economic-demographic information the user becomes a member of the service.

A member who accesses the portal 14 by means of at least one user interface 11 may decide whether to participate in a discussion group for exchanging information specific to one particular product or service or, if such does not exist, to create a new one. All the discussion groups make all together up the virtual community.

According to the invention, by participating to the community, the members also participate to the capital of the company, which manages the community as will be seen later in more detail. This improves the commitment of the members and the reliability of their participation in the community activities.

If the member does not find a discussion group for the product or service of interest, he can create one by means of defining a questionnaire about the product or service discussed in the new group and which a new participant will have to complete in order to participate in the group.

The creation of a new group can possibly require the supervision of the administrative staff of the system. The creation of the questionnaire follows criteria defined in advance by the devices 15 for collecting and processing data in order to guarantee collection of data that is consistent and related to the topics regarded to be of particular interest to the customer companies.

Purely as an example and in no way intended to be exhaustive, the devices 15 for collecting and processing data could require the user to put mandatory questions in the questionnaire, for example:
What is your level of satisfaction with the product?
Do you like it?
Do you have a personal/commercial/professional relationship with the product/service or with its maker/provider?
Would you buy it?
Have you bought it?
Do you consider that it is worth the price you paid (price/quality ratio)?
Is your experience positive?
Do you intend to repeat the experience?
Which characteristic of the product/service do you consider most important?
What defects does the product/service have?

The questionnaire can include both open and closed questions.

The method of answering the questions asked is defined either by means of a graded scale which gives for example ten intervals defined using the expressions “I absolutely disagree”, “I absolutely agree” and suchlike, or by expressing the user's opinion by means of selecting a specific answer subheading.

Once the discussion group for a product or service has been created, the participants to the discussion group can add further activities related to the product or service like polls, forum, surveys, reviews, etc.

If a discussion group already exists for the product or service of interest to the user, he/she can join this group by inputting the data required by means of the questionnaire defined when the discussion group was created.

In order to guarantee a data set that is consistent, for the quantitative assessment part, there will be a mechanism for controlling the completion of the questionnaire for a product/service by the same user.

For example, the system will not allow the questionnaire to be completed more frequently than a predefined interval.

In addition, in the subsequent step of processing the data, the number of participations to the group activities by the same member will be accounted for by means of suitable methods of statistical analysis.

In order to motivate active and reliable participation in the discussion groups, the method for electronic data collection about products or services according to the present invention innovatively includes a remuneration for members of the community, which is also dependent on the global profit all the discussion groups making, all together up the virtual community.

By remuneration is meant a valorization—for instance in monetary terms or other instruments giving the member some rights to a fraction of the company capital (e.g. fractional shares, stock options or other forms of options)—of the contributions to the activities of the discussion groups in terms of given information, assessments, constructive criticisms, and suchlike, about the products/services discussed in the group.

Upon signing up to the data exchange service, namely to the virtual community, following the profiling of the member and provided that the member has participated to at least one discussion group, every predefined time interval, for example on a quarterly basis, the member obtains the right to participate in the distribution of remuneration, for instance by means of obtaining a presence chip or token.

All members who submit contributions to a discussion group in terms of objective data, opinions, and experiences about the specific product or service will be remunerated, in monetary terms, or other instruments giving the member some rights to a fraction of the company capital (e.g. fractional shares, stock options or other forms of options).

However, the remuneration in monetary terms takes place by means of an equable sharing of a percentage of the company earnings, if the results of the survey are purchased and paid for by third parties, whereas the remuneration of the users participating in a discussion group in terms of instruments giving them the right to a fraction of the company capital, takes place independently from the sale of the processed market information.

The remuneration is calculated for each individual participant based on calculation parameters like for instance his or her participation frequency and/or the quality of his or her contributions.

The evaluation of the quality of the contributions input by the participants to a group and thus the correct distribution of the earnings of such group is implemented through the rating of the participant's activities.

For a founding member of a discussion group or for other specific member profiles, for example members who participate diligently, there may be additional incentives, in terms of money and/or of other instruments giving the member some rights to a fraction of the company capital (e.g. fractional shares, stock options or other forms of options).

Such additional incentives are commensurate to the stimulus of members to participate actively in the specific discussion group aimed at assessing the specific product or service, deriving for example from the performance of the function of moderator of the founding member.

Lastly, all members with the right to participate in the sharing of profits will be remunerated, in monetary terms or with other instruments giving the member some rights to a fraction of the company capital (e.g. fractional shares, stock options or other forms of options), with a percentage of the profits as it appears in the approved financial statements, calculated for each individual member on the basis of his or her participation in terms of quality and/or quantity.

The data collected, both by means of inputting upon joining a discussion group, and by means of participating in the exchange of information in the discussion group, is saved in the database 16 and processed 120 by the devices 15 for collecting and processing data in order to obtain relevant information about the specific product or service. The processing 120 of the data collected takes place also through a proprietary search engine based on user generated ratings, tags and content.

The information thus obtained is offered for sale 130 to companies that may be interested, for example the makers of the particular product or the providers of the particular service covered by the discussion group, competing companies, market research and consultancy companies, and suchlike.

If interest is expressed by a company in purchasing the information offered for sale, the method for the electronic collection of data about products or services according to the present invention includes, completely innovatively, a redistribution 140 of the earnings made through said sale to the members of the discussion group.

In this way, the individual user is spontaneously stimulated to actively participate in the discussion group by inputting only relevant data, because his or her remuneration also includes a variable component that depends on the market appeal of the results achieved by the discussion group. In fact, the successful outcome of these results depends not only on the quantity, but also on the quality of the data input.

Additionally, users, which have participated in a discussion group, are remunerated 150 in terms of instruments giving them the right to a fraction of the company capital, independently from the sale of the processed market information.

This stimulates the participation of the users in the community activities from the beginning, when the collected information is still not sufficiently complete to be offered for sale.

According to a particular embodiment of the present invention depicted in FIG. 3, the system 10 for electronic data collection preferably contains four subsystems (in the following, by referring to products, reference is made also to services):
a people web-community 14,15. In order to participate in the web-community, a user should sign up for the community upon invitation and/or on his own initiative;
a secure web-site 17a accessible by subscribers only, enabling to access all product related information derived from the people web-community;
a public presentation web-site 18a, preferably with enhanced search capabilities, which contains just selective product data, like product ratings, and other statistical data derived from the people web-community 14,15. The public site 18a has also a subscription service, that enables companies to subscribe to the secure web-site 17a;
an administration console 19 that enables the staff to manage user requests and execute administrative tasks.

The subsystems “people web-community”, “secure web-site” and “public web-site” are linked together by common system objects, which are the products:
the people web-community 14,15 collects data and generates information on the products through activities in related discussion groups 20 within the community;
the secure web-site 17a is a market place where the generated information on the products is offered; and
the public web site 18 can both contribute to the generation of information on the products and get free access to part of the generated information on the products.

Anonymous users 18 are able to access the public web-site 18a only.

To access more detailed reports, users should become a member of the people community 14,15 or subscribe as a customer of the secure web-site 17a.

### People Web-Community

The web-community 14,15 allows the following community users: Registered Members, Verified Members, Expert Club and Administrators.

“Registered Members” have registered within the community but perform limited networking activities.

The score gained by these users through their limited contribution to the community activities does not convert to real money or to other forms of remuneration and their polls and/or opinions have less weight than normal.

“Verified Members” are users that additionally to “Registered Members” have provided residence and fiscal information and have been verified against the validity of data provided. These users can perform general networking activities but the score gained through said activities does not convert to money or to other forms of remuneration.

“Expert Club Members” are users that additionally to “Verified Members” own a credit card issued by the system partners. Those users convert their score to money or other instruments giving the member some rights to a fraction of the company capital (e.g. fractional shares, stock options or other forms of options).

“Administrators” perform day-to-day content management and moderation tasks in the community.

The community members also gain expertise levels, based on their score like e.g. “Stagier”, “Specialist”, “Expert Participant”, and “Black Belt”.

Additionally, the community members can gain an item related expert level, namely be experts in products, brands and/or companies.

By way of example, in order to become an expert in the given product, the community members must get at least one best answer.

In order to become an expert in brand, the community member should be an expert in at least 30% of brand-related products, and in order to become an expert in a company, the community member should become an expert in at least 30% of company products.

The community members have the following attributes:
personal attributes, the minimum required to register in the community. Like e.g. name/surname, sex, age, e-mail address, a picture or a default avatar for “expertise level” to be assigned, and a time zone.
fiscal attributes, required to become a verified member. Verification is needed for these attributes. The address of the member is used in many places, including in the score calculation where the weight of the member opinion is changed basing on his location in relation to the products.
credit card attributes, required to become an expert club member and for issuing a community credit card;
web attributes, like “my profile”, “my blog”, the sites the member recommends, the web-community profile etc.;
activity attributes, relating to all member actions, which are saved in a “User Activity Log”. The “User Activity Log” is the main source for all activity based calculations and/or integration. The log can be viewed by the member and by the administration staff only;
expertise areas, which are products, brands and companies of bigger expertise for a member;
member bookmarks to forums and or queries, which are like web-bookmarks in order to be forwarded to a particular topic through selecting the bookmark. Member bookmarks can be shared with other members;
“My friends' feed”, which is a combined feed of activities of members' friends. A member should be able to view the feed of his friends. For example if a member enters a tab he sees a log which contains “<member name> has done <some action> on the <system object>” where <member name> and <system object> are URLs (Uniform Resource Locator) to be able to jump to the related pages from the log directly. There is also an option to search for members within the system and look for their activities;
“My Favorite Brands” which is a tab which enables a member to put together the list of his favorite brands or products. The member can select brands from the list of available ones and the resulting “Brand Map” will be visible for his friends depending on visibility settings. If any brand has been selected as a favorite, the member will get notifications once a new product has been added under the selected brand.
“My User Guides”, which are product reviews that have been selected by the community as a user guide for products.

The core system objects on which the web-community is based are products.

Products are classified within the web-community through a system of classification that includes categorization, attributes and tagging of any particular product.

First, there are two category trees, wherein the first categories tree has three nesting levels and includes the industry sector, the company and the brand, and the second categories tree has two nesting levels and includes product types and subtypes.

Any products can be accessed using different ways, namely one product can be included in one or more different categories or subcategories.

Second, attributes are used to define the products more clearly and can be suggested by members and added by administrators.

Basically, an attribute can be suggested by members posting a new topic or performing a search.

In this case, there will be a list of available attributes or the possibility to suggest a new one by adding an attribute and a related value. Values of available attributes can also be added by members.

As additional classification, targeted primarily on discussion topics, tags may be added to any post. Tags will be completely free text without the need of any intervention by administrators.

Each product homepage has a “Tag Cloud” that includes most often used tags ranked on how frequently this tag has been used.

A member can search by tag by entering his query into a free text field.

Information on products is generated by the activities on products in the web-community, which is evaluated through ratings.

All system objects can be rated within the system.

Basic purpose of these ratings is to assign objects' weight, i.e. a relevance indication, within the system, which influences all weights related to this object.

Each product is given a rating, which is changed overtime by the community members.

Basically, the system has twenty pre-defined rating questions.

Once an administrator enters a new product, thereby creating a related discussion group, he can select appropriate questions/criteria from a list of available ones.

The administrator has to answer those questions when submitting a new product and the devices for collecting and processing data 15 calculate the rating of the product based on his answers.

Additionally, rating widgets are displayed within the system 10 along with product information.

For example, the following widgets are available:
Global Product Rating: X points out of a total number of points;
Number of forums about the products: X active, Y total;
Product rating is increasing or decreasing, in respect of the previous day;
A link to detailed products report on a public site;

In order to create a new forum and/or poll for the products, a member must rate the products first.

The system 10 offers the questions selected by the administrator for this product.

In order to post any opinion, a member is suggested to rate as well.

The member's rate is valid for a pre-defined period of time, which is set by the administrator while entering the product.

Once the rate is expired, the member is offered to rate the product next time he is performing any action with regards to this product.

The system 10 stores rating historical data, which afterwards is delivered to the customers having subscribed to the secure web-site 17a as reports.

Ratings are displayed also on the public web-site 18a. On the public site 18a anonymous users may also vote for the selected products, and their votes is included into the rating form as comparison with the web-community opinion and identified as “public”.

Further system objects, which can be rated, are entities added by members in response to product posts. Any system object (forum, poll, etc) or its part (reply in a forum) can be flagged by any other community member for review by the administrator. Flagging content means this member thinks it has not appropriate content.

Preferably, all posted objects have a timestamp of local time for the current members, wherein the local time is taken from the member's profile. All posts have a country flag of authors' country taken from the profile for verified members.

The system has the following objects, related to products:
Poll: a multi-choice radio-button with either yes/no/not sure, or 1-10 rate. The poll is a single page query having a subject, a description (optional), one question and a plurality of alternatives for answer;
Forum: is a discussion on a topic related to a product having a specific subject or title, a description, and may contain a poll inside. In this case the poll is not taken from the list of polls, but is a new one created as part of the forum.

A forum may have some tags initially assigned to it by the creator. And when saved to “My bookmarks” by a user the other even different tags may be assigned also.

People may reply to the forum, and tag the new reply (only the one who makes this reply) and change subject.

An active form of reply is a free text reply.

A passive form of reply is to only vote in the poll if one exists inside the forum. This action has another weight or score value as the action of active reply.

The list of replies to a forum can be ordered by date or by rating.

Every forum should have an end-date, or be permanent.

If the forum is permanent, its creator is notified and invited to close or renew the forum when the end-date is reached.

If no action is taken, the forum is considered as closed within a pre-established time period.

Periodically or when closing a forum, its creator is proposed to select the best answers. Those with best answers become “Experts for product X” and receive a corresponding score;
Survey: is a few page questionnaire wizard that drives the user through few polls. There is one poll on every page, and the survey is not complete until the last page is reached. Authorized members can create such surveys using a custom survey creation tool;
Review: is text information entered by verified members with regards to products. A member can input only one review per product and in future modify this review. The community can vote for this review, and the one with most rating is marked as a “User Guide”. User guides are displayed on a product page of the public web site. For each most rated review the author gets a star, which is placed on an appropriate tab in his profile. The stars are involved in the score calculations.

The subject of forum, polls, surveys and reviews, can be read and voted as useful or useless (e.g. 1 to 10 points).

From the same list of objects, users are allowed to bookmark any object to his “favorite”, with a personal tag assigned.

The same is possible from inside the forum, polls, and surveys to rate it before or after having participated in forum, polls or surveys.

In case of a forum, it is possible to rate in the same way also the replies of other users. This also updates the score of the person replied.

A member is further able to rate another member in the contest of a product expertise. So every vote as expert affects the product or brand expert score and also the global score.

It is also possible to recommend a poll, forum or survey in order to signalize this object to one or more of the member's friends.

“Recommend a topic” is also a system action which has some weight assigned.

In addition, also members can be rated within the system. Members can vote for other community members, thus influencing their weight and the weight of their opinions regarding other objects.

People by participating earn score on the base of their contributions.

In this case, every networking action, like e.g. to create a new topic, to add a new poll to the topic, to invite people who join the community and/or vote for a product etc., has a fixed score assigned to it.

In the system, other members can rate every object created by a member in order to generate score for him/her. It is to encourage members to create new relevant system objects in the network.

The algorithms used for the rating of system objects are based on the following basic principle:
a product is always related to a country of distribution, wherein the country should be selected when new a product is created within the community;
a brand has a country of reference or is worldwide;
a company has a country of reference or is worldwide.

The algorithms further take into considerations different criteria like for instance the member's location in connection with the product, the member status, his expertise level, his brand and/or product expertise, etc.

According to the present invention, at regular intervals of time, the collected score is converted to money or to fractional ownership forms.

The remuneration is transferred once a period to the personal account of the related member. Preferably, if the remuneration is under form of money, the amount is transferred on the community credit card (issued on standard circuits, like Visa for instance) or on other banking instruments (e.g. bank account, PayPal®, etc).

### Secure Web Site

The secure web site is a part of the system, which can be accessed by subscribers (customers) to get reports.

Basically, this is a web site for Companies.

Two types of subscriptions for customers are foreseen: standard and premium.

Standard customers can generate quality reports on certain number of products, whilst for premium customers premium reports are available.

A customer may select the period of subscription where he can access the secure web site to generate reports.

The reports, which can be generated from the data collected through the web-community activities, are the following:
a summary report for a selected product, which displays the list of topics and questions for any selected product for a pre-defined period of time. Summary reports are available for all users (public users, web-community members and customers);
a detailed report for a selected product, which displays all correspondence for selected products for a pre-defined period of time. Detailed reports are available for verified members of the web-community and customers;
a quality report, which takes into account the quality of all system entries by considering the related weights. Quality reports are available for customers only;
a premium report developed using database queries and uploaded into the system. Premium reports are available only for premium customers and there is a search facility, which enables customers to perform search match document titles.

From the description given the characteristics of the method and of the system comprised in the present invention are clear, as are the advantages.

Lastly, it is clear that the system so conceptualized is open to numerous modifications and variants, all of which come under the scope of the invention; in addition all details can be substituted by elements that are technically equivalent.

1. Method (100) for the electronic collection of data about products or services through a virtual community made up of a plurality of discussion groups wherein the virtual community is managed by a company, the method comprising the steps consisting of:
a) receiving (110) a plurality of data about the product or service from a plurality of users participating in a discussion group about a product or service;
b) processing (120) the input data in such a way as to obtain market information about the product or service;
c) offering for sale (130) the processed market information;
d) redistributing (140) a percentage of the company earnings obtained from the sale of the information among the users of the discussion group in terms of money or an instrument giving the users the right to a fraction of the company capital.

2. Method (100) for the electronic collection of data about products or services according to claim 1 further comprising the step of:
e) remunerating (150) the users participating in a discussion group which have provided the information received in step a) in terms of instruments giving them the right to a fraction of the company capital, independently from the sale of the processed market information.

3. Method (100) for the electronic collection of data about products or services according to claim 1 in which the percentage of earnings is redistributed to the users in a different manner, based on the frequency of participation of each user.

4. Method (100) for the electronic collection of data about products or services according to claim 3 in which the plurality of users participates in the redistribution of the contribution if it has participated in at least one discussion group for a predefined time interval.

5. Method (100) for the electronic collection of data about products or services according to claim 4 in which the predefined time interval is three months.

6. Method (100) for the electronic collection of data about products or services according to claim 1 in which the step of reception (110) of a plurality of data about a product or service consists of at least one of the following steps:
a1) founding the discussion group by means of the guided definition of a questionnaire about the product or service;
a2) join the discussion group by means of completing the questionnaire;
a3) contributing to the discussion group by inputting information on the product or service;
a4) using a community credit card for purchasing goods and/or services.

7. Method (100) for the electronic collection of data about products or services according to claim 6 in which the questionnaire defined during step a1) comprises open and/or closed questions.

8. Method (100) for the electronic collection of data about products or services according to claim 6 in which the step a3) of contributing to the discussion group comprises creating, participating to or rating a poll, a forum, a survey or a review.

9. Method (100) for the electronic collection of data about products or services according to claim 1 in which the plurality of data about a product or service received during the step of reception (110) includes quantitative and/or qualitative data.

10. Method (100) for the electronic collection of data about products or services according to claim 1 in which the step of data processing (120) is based on the ratings which discussion group participants give to the collected data and/or to the activities used to collect the data and/or to other participants which entered the data.

11. Method (100) for the electronic collection of data about products or services according to claim 10 in which the step of data processing (120) is further based on the rating given on a product or service by anonymous users not registered to the virtual community.

12. Method (100) for the electronic collection of data about products or services according to claim 11 in which each user collects a score based on his/her activities and on the ratings which he/she has been given and the ratings given to his/her activities in the discussion groups to which he/she has participated and the percentage of the earnings is distributed to the users based on the score collected by each user.

13. Method (100) for the electronic collection of data about products or services according to claim 12 in which the collected score is converted to money and/or instruments giving the member the right to a fraction of the company capital.

14. Method (100) for the electronic collection of data about products or services according to claim 1 in which the step of redistribution of a percentage of the company earnings in terms of money, comprises the transferring of money on the community credit card of the user or on other banking instruments.

15. Method (100) for the electronic collection of data about products or services according to claim 1 in which the data processing step (120) feeds for a proprietary search engine based on user generated ratings, attributes, tags and other content.

16. Method (100) for the electronic collection of data about products or services according to claim 1 in which the data processing step (120) generates reports on the specific product or service.

17. Electronic system (10) for the collection of data about products or services comprising a plurality of user interfaces (11) for accessing a communications network (12), the network (12) interfacing with a unit (13) for managing data about products or services, comprising
a portal (14) for receiving (110) a plurality of data about the product or service from a plurality of users through the plurality of user interfaces (11);
devices for collecting and processing data (15) in such a way as to obtain market information about the product or service; and
databases (16) for storing the data;
wherein the unit (13) for managing data about products or services is connected to at least one terminal (17) of a commissioning customer company for offering for sale (130) the processed market information; further wherein means for redistributing a percentage of the company earnings obtained from the sale of the information among the users of the discussion group in terms of money or an instrument giving the users the right to a fraction of the company capital are provided.

18. Electronic system (10) for the collection of data about products or services comprising a plurality of user interfaces (11) for accessing a communications network (12), the network (12) interfacing with a unit (13) for managing data about products or services, comprising
a portal (14) for receiving (110) a plurality of data about the product or service from a plurality of users through the plurality of user interfaces (11);
devices for collecting and processing data (15) in such a way as to obtain market information about the product or service; and
databases (16) for storing the data;
wherein the unit (13) for managing data about products or services comprises a second portal (17a) which allows the access to the unit (13) for managing data about products or services through the communication network (12) of at least one terminal (17) of a commissioning customer company; further wherein means for redistributing a percentage of the company earnings obtained from the sale of the information among the users of the discussion group in terms of money or an instrument giving the users the right to a fraction of the company capital are provided.

19. Electronic system (10) for the collection of data about products or services according to claim 18 in which the unit (13) for managing data about products or services comprises a third portal (18a) which allows a limited access to the unit (13) for managing data about products or services of anonymous users (18).
